(19) United States
(12) Patent Application Publication
(10) Pub. No.: US 2021/0165183 A1
(43) Pub. Date: Jun. 3, 2021

(54) ACTUATOR AND CAMERA DEVICE

(71) Applicant: PANASONIC INTELLECTUAL PROPERTY MANAGEMENT CO., LTD., Osaka (JP)

(72) Inventors: Yasuaki KAMEYAMA, Osaka (JP); Hironori TOMITA, Nara (JP); Masahiro INATA, Hyogo (JP); Katsunobu SUZUKI, Osaka (JP)

(21) Appl. No.: 16/759,267

(22) PCT Filed: Sep. 21, 2018
(86) PCT No.: PCT/JP2018/035156

§ 371 Date: Apr. 24, 2020

(30) Foreign Application Priority Data
Oct. 31, 2017 (JP) 2017-210563

(51) Int. Cl. G02B 7/02; G02B 27/64; G03B 5/00; G03B 30/00; H04N 5/225

(52) U.S. Cl. CPC G02B 7/02; G02B 27/646; G03B 2205/0007; G03B 30/00; H04N 5/2253; G03B 5/00

(57) ABSTRACT

An actuator includes: a movable unit to hold an object to be driven; a fixed unit to support the movable unit thereon to make the movable unit rotatable; and a structure for supporting the movable unit with respect to the fixed unit. The structure includes: a sphere; and a pair of holding members to clamp the sphere between themselves. A space is left to let the sphere roll while shifting a center position thereof with respect to at least one of the pair of holding members.

### TECHNICAL FIELD

The present disclosure generally relates to an actuator and a camera device, and more particularly relates to an actuator and camera device configured to drive an object to be driven in rotation.

### BACKGROUND ART

An actuator for rotating a camera has been known as an actuator for rotating an object to be driven in rotation. For example, Patent Literature 1 discloses a camera driver (camera device) with the ability to rotate a camera unit in three axis directions. The camera driver disclosed in Patent Literature 1 includes: a movable unit including, on its outer surface, a convex partial sphere; and a fixed unit which has a recess, in which the movable unit is loosely fitted at least partially, in which the surface of the convex partial sphere and the recess make point or line contact with each other, and which causes the movable unit to rotate by electromagnetic driving around the center of the convex partial sphere.

In the camera driver (actuator, camera device) of Patent Literature 1, the convex partial sphere of the movable unit is loosely fitted into the recess of the fixed unit to have the movable unit supported by the fixed unit. If the device is used so as to constantly rest and move repeatedly, while the movable unit is standing still with respect to the fixed unit, at least the loosely fitted part of the movable unit and the fixed unit are coupled together via static friction, thus letting the coupled parts behave as a rigid body. When the movable unit and the fixed unit start to move, a so-called “stick slip,” which is a self-excited vibration caused by a variation in static and sliding frictions, occurs. A torque pulsation caused by this stick slip has a saw-toothed sharp waveform, which excites (i.e., produced resonance of) the characteristic vibration that the rigid body coupled together during the static period owns, thus causing instability to the rotational control system temporarily. In addition, this phenomenon also arises in the process during which the object in motion is going to rest, thus constituting a factor eventually causing a decline in the positioning accuracy of the rotational control.

### CITATION LIST

### Patent Literature

Patent Literature 1: WO 2012/004952 A1

### SUMMARY OF INVENTION

In view of the foregoing background, it is therefore an object of the present disclosure to provide an actuator and camera device configured to allow the movable unit to start and stop moving smoothly at an initial stage of its rotary motion.

An actuator according to an aspect of the present disclosure includes: a movable unit configured to hold an object to be driven; a fixed unit configured to support the movable unit thereon to make the movable unit rotatable; and a structure for supporting the movable unit with respect to the fixed unit. The structure includes: a sphere; and a pair of holding members configured to clamp the sphere between themselves. A space is left to let the sphere roll while shifting a center position thereof with respect to at least one of the pair of holding members.

A camera device according to another aspect of the present disclosure includes: the actuator described above; and a camera module serving as the object to be driven.

### BRIEF DESCRIPTION OF DRAWINGS

FIG. 1A is a cross-sectional view of a camera device including an actuator according to an embodiment of the present invention;

FIG. 1B illustrates a supporting structure for the camera device;

FIG. 2A is a perspective view of the camera device;

FIG. 2B is a plan view of the camera device;

FIG. 3 is an exploded perspective view of the camera device;

FIG. 4 is an exploded perspective view of the movable unit that the actuator includes;

FIGS. 5A-5C illustrate a structure that allows the movable unit to rotate;

FIG. 6 illustrates a relation between the radius of a spherical surface of a fixed-end holding member and the radius of a sphere when the sphere rolls on the fixed-end holding member that the actuator includes;

FIG. 7 illustrates a relation between the radius of a spherical surface of a movable-end holding member and the radius of the sphere when the sphere rolls on the movable-end holding member that the actuator includes;

FIG. 8 illustrates a relation between the radius of the spherical surface of the fixed-end holding member, the radius of the spherical surface of the movable-end holding member, the radius of the sphere, and frictional force;

FIG. 9 shows a relation between the radius of the spherical surface of the fixed-end holding member, the radius of the spherical surface of the movable-end holding member, and the radius of the sphere when frictional force is taken into account by the camera device;

FIG. 10 shows a relation between the radius of the spherical surface of the fixed-end holding member, the radius of the spherical surface of the movable-end holding member, and the radius of the sphere when reduction in the deformation of the sphere is taken into account by the camera device;

FIG. 11 shows the magnitude of movement of a sphere when the magnitude of movement of the sphere is taken into account by the camera device;

FIG. 12 shows a relation between the radius of the spherical surface of the fixed-end holding member, the radius of the spherical surface of the movable-end holding member, and the radius of the sphere when the magnitude of movement of the sphere is taken into account by the camera device; and

FIG. 13 shows a relation between the radius of the spherical surface of the fixed-end holding member, the radius of the spherical surface of the movable-end holding member, and the radius of the sphere when the frictional force, reduction in the deformation of the sphere, and the magnitude of movement of the sphere are taken into account by the camera device.

### DESCRIPTION OF EMBODIMENTS

Note that embodiments and their variations to be described below are only examples of the present invention and should not be construed as limiting. Rather, those embodiments and variations may be readily modified in various manners depending on a design choice or any other factor without departing from a true spirit and scope of the present invention. The drawings to be referred to in the following description of the first embodiment are all schematic representations. That is to say, the ratio of the dimensions (including thicknesses) of respective constituent elements illustrated on the drawings does not always reflect their actual dimensional ratio.

### First Embodiment

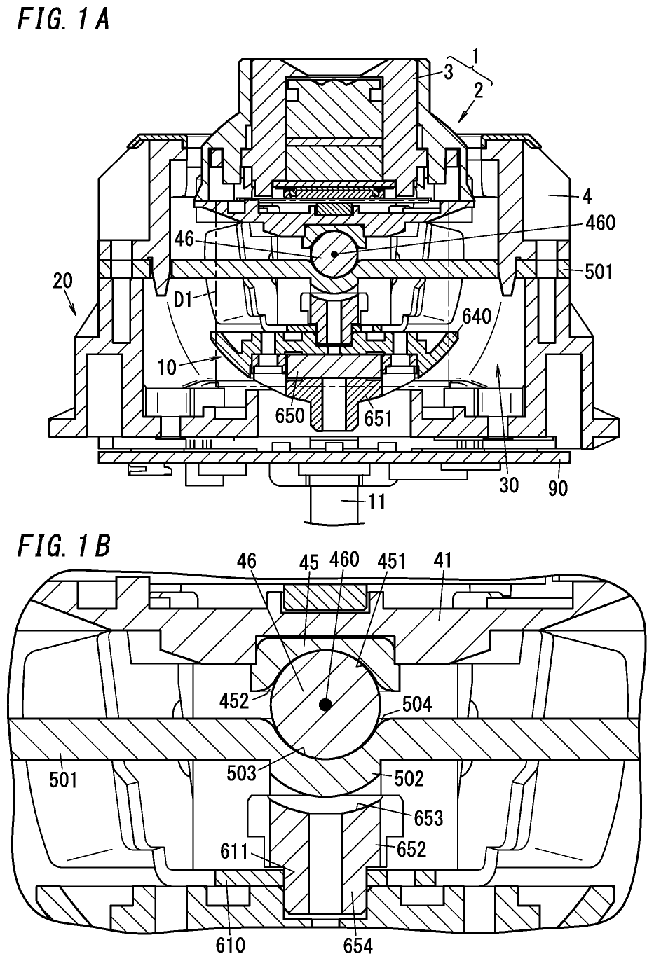

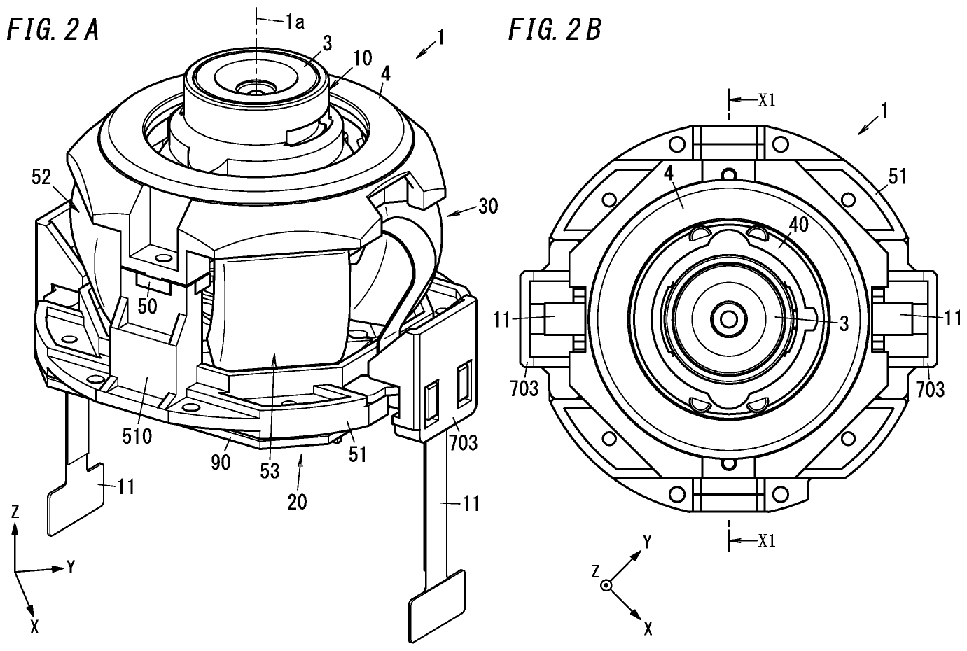

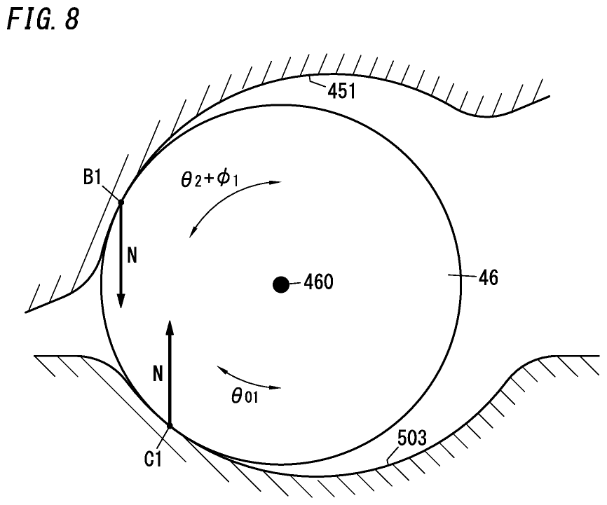

A camera device according to this embodiment will be described with reference to FIGS. 1A-13. FIG. 1A is a cross-sectional view taken along the plane X1-X1 shown in FIG. 2B. FIG. 1B is an enlarged view of the main part D1 shown in FIG. 1A.

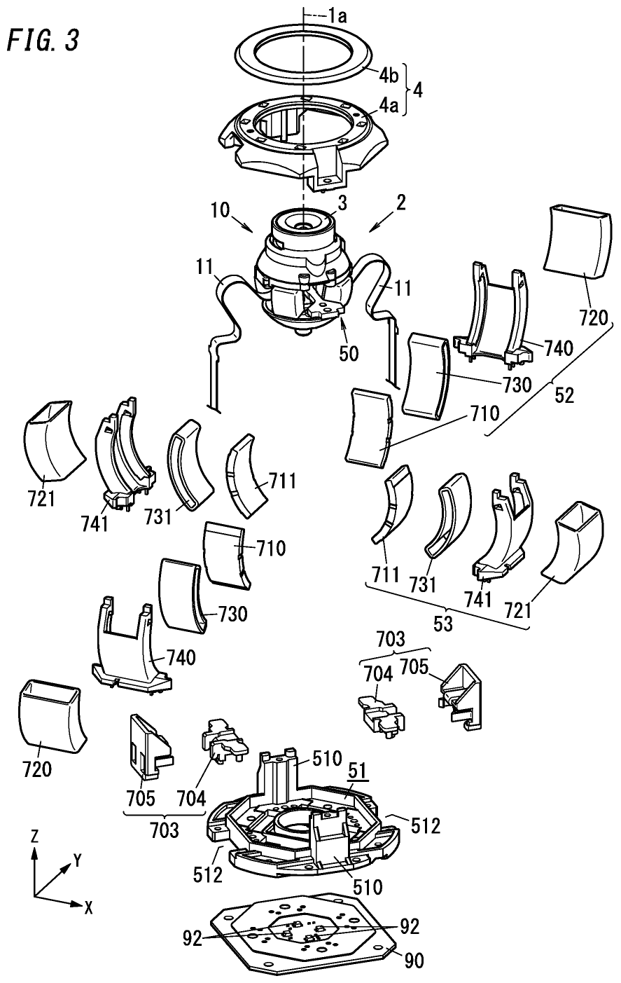

The camera device 1 may be a portable camera, for example, and includes an actuator 2 and a camera module 3 as shown in FIGS. 2A and 3.

The camera module 3 includes an image sensor, a lens for forming a subject image on the image capturing plane of the image sensor, and a lens barrel for holding the lens. The camera module 3 converts video produced on the image capturing plane of the image sensor into an electrical signal. Also, a plurality of cables to transmit the electrical signal generated by the image sensor to an external image processor circuit (as an exemplary external circuit) are electrically connected to the camera module 3 via a connector. The camera module 3 transmits, by the low voltage differential signaling (LVDS) method, the electrical signal thus generated to the external image processor circuit via the plurality of cables. Note that in this embodiment, the plurality of cables includes coplanar waveguides or micro-strip lines. Alternatively, the plurality of cables may each include fine-line coaxial cables each having the same length. Note that the LVDS method is only an example and should not be construed as limiting. Those cables are grouped into two bundles of cables 11 so that each bundle of cables 11 consists of the same number of cables. The bundles of cables 11 may be implemented as flexible flat cables, for example. One end of the bundle of cables 11 is electrically connected to the camera module 3 and the other end of the bundle of cables 11 is electrically connected to the image processor circuit.

The actuator 2 includes an upper ring 4, a movable unit 10, a fixed unit 20, a driving unit 30, and a printed circuit board 90 as shown in FIGS. 1A and 2A.

The upper ring 4 consists of a first ring 4a and a second ring 4b. The upper ring 4 fixes first coil units 52 and second coil units 53 to be described later.

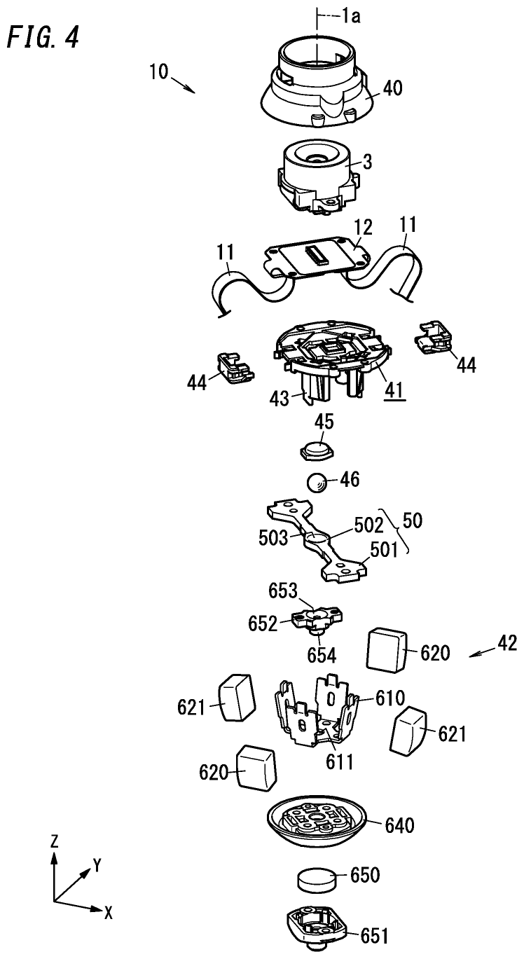

The movable unit 10 includes a camera holder 40, a first movable base 41, and a second movable base 42 (see FIG. 4). The movable unit 10 is fitted into the fixed unit 20. The movable unit 10 rotates (i.e., rolls) around the optical axis 1a of the lens of the camera module 3 with respect to the fixed unit 20. The movable unit 10 also rotates around an X-axis and a Y-axis, which are both perpendicular to the optical axis 1a, with respect to the fixed unit 20. In this case, the X-axis and the Y-axis are both perpendicular to a fitting direction, in which the movable unit 10 is fitted into the fixed unit 20 while the movable unit 10 is not rotating. Furthermore, these X- and Y-axes intersect with each other at right angles. A detailed configuration for the movable unit 10 will be described later. The camera module 3 has been mounted on the camera holder 40. The configuration of the first movable base 41 and the second movable base 42 will be described later. Rotating the movable unit 10 allows the camera module 3 to rotate. In this embodiment, when the optical axis 1a is perpendicular to both of the X- and Y-axes, the movable unit 10 (i.e., the camera module 3) is defined to be in a neutral position. In the following description, the direction in which the optical axis 1a extends when the movable unit 10 is in the neutral position is defined herein as a “Z-axis direction.” The direction of movement of the movable unit 10 in which the movable unit 10 rotates around the X-axis is defined herein as a “panning direction” and the direction of movement of the movable unit 10 in which the movable unit 10 rotates around the Y-axis is defined herein as a “tilting direction.” While the movable unit 10 is not driven by the driving unit 30 (i.e., in the state shown in FIG. 3A and other drawings), the optical axis 1a of the camera module 3, the X-axis, and the Y-axis intersect with each other at right angles.

The fixed unit 20 includes a coupling member 50 and a body 51 (see FIG. 3).

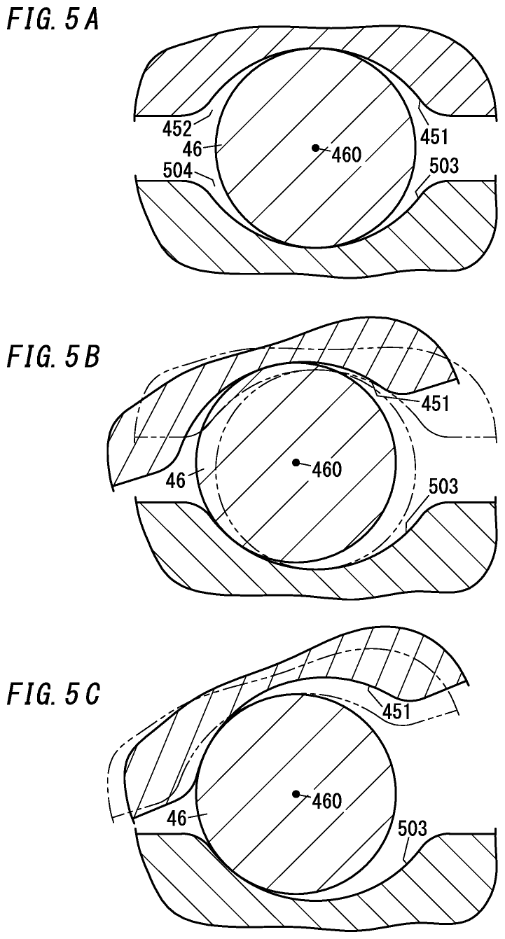

The coupling member 50 includes a linear coupling bar 501 and a fixed-end holding member 502. The fixed-end holding member 502 is provided for a central portion of the coupling bar 501. The fixed-end holding member 502 has a recessed spherical surface 503 at a central portion thereof. The fixed-end holding member 502 holds a resin-molded sphere 46 (see FIG. 4). The radius of the recessed spherical surface 503 is larger than the radius of the sphere 46. In other words, the recessed spherical surface 503 and the sphere 46 have mutually different curvatures. That is to say, when the fixed-end holding member 502 holds the sphere 46 (i.e., when the sphere 46 comes into contact with the recessed spherical surface 503), a space 504 is left (see FIGS. 1B and 5A). The space 504 left lets the sphere 46 roll on the recessed spherical surface 503 such that the center 460 of the sphere 46 shifts (see FIGS. 1A and 1B). The coupling member 50 is made of aluminum and the surface of the recessed spherical surface 503, in particular, is subjected to alumite (anodized aluminum) treatment.

The body 51 includes a pair of protrusions 510. The pair of protrusions 510 are provided so as to face each other in a direction perpendicular to the optical axis 1a of the movable unit 10 in the neutral position. The pair of protrusions 510 are also provided to be located in the gaps between the first coil units 52 and second coil units 53 arranged (to be described later). The coupling member 50 is screwed onto the body 51 with the second movable base 42 interposed between itself and the body 51. Specifically, both ends of the coupling member 50 are respectively screwed onto the pair of protrusions 510 of the body 51.

The body 51 is provided with two fixing portions 703 for fixing the two bundles of cables 11 thereto (see FIGS. 2A-3). The two fixing portions 703 are arranged to face each other perpendicularly to the direction in which the pair of protrusions 510 are arranged. Each of the two fixing portions 703 includes a first member 704 and a second member 705 (see FIG. 3). An associated bundle of cables 11 is partially clamped between the first member 704 and the second member 705 fitted into a cutout 512 of the body 51.

The fixed unit 20 includes a pair of first coil units 52 and a pair of second coil units 53 to make the movable unit 10 electromagnetically drivable and rotatable (see FIG. 3). The pair of first coil units 52 allows the movable unit 10 to rotate around the X-axis. The pair of second coil units 53 allows the movable unit 10 to rotate around the Y-axis.

The pair of first coil units 52 each include a first magnetic yoke 710 made of a magnetic material, drive coils 720 and 730, and a magnetic yoke holder 740 (see FIG. 3). Each of the first magnetic yokes 710 has the shape of an arc, of which the center is defined by the center of rotation. The drive coils 730 are each formed by winding a conductive wire around its associated first magnetic yoke 710 such that its winding direction is defined around the X-axis (i.e., the direction in which the second coil units 53 face each other) and that the pair of first drive magnets 620 (to be described later) are driven in rotation in the rolling direction. As used herein, the winding direction of the coil refers in this embodiment to a direction in which the number of turns increases. The respective first magnetic yokes 710 are arranged in their associated magnetic yoke holders 740. The drive coils 720 are each formed by winding a conductive wire around its associated first magnetic yoke 710 arranged in its corresponding magnetic yoke holder 740. The drive coils 720 have their winding direction defined around the Z-axis such that the pair of first drive magnets 620 are driven in rotation in the panning direction. Then, the pair of first coil units 52 are secured with screws onto the body 51 so as to face each other when viewed from the camera module 3. Specifically, each of the first coil units 52 has one end thereof (i.e., the end opposite from the camera module 3) along the Z-axis secured with a screw onto the body 51. Each of the first coil units 52 has the other end thereof along the Z-axis (i.e., the end facing the camera module 3) fitted into the upper ring 4.

The pair of second coil units 53 each include a second magnetic yoke 711 made of a magnetic material, drive coils 721 and 731, and a magnetic yoke holder 741 (see FIG. 3). Each of the second magnetic yokes 711 has the shape of an arc, of which the center is defined by the center of rotation. The drive coils 731 are each formed by winding a conductive wire around its associated second magnetic yoke 711 such that its winding direction is defined around the Y-axis (i.e., the direction in which the first coil units 52 face each other) and that the pair of second drive magnets 621 (to be described later) are driven in rotation in the rolling direction. The respective second magnetic yokes 711 are arranged in their associated magnetic yoke holders 741. The drive coils 721 are each formed by winding a conductive wire around its associated second magnetic yoke 711 arranged in its corresponding magnetic yoke holder 741. The drive coils 721 have their winding direction defined around the Z-axis such that the pair of second drive magnets 621 are driven in rotation in the tilting direction. Then, the pair of second coil units 53 are secured with screws onto the body 51 so as to face each other when viewed from the camera module 3. Specifically, each of the second coil units 53 has one end thereof (i.e., the end opposite from the camera module 3) along the Z-axis secured with a screw onto the body 51. Each of the second coil units 53 has the other end thereof along the Z-axis (i.e., the end facing the camera module 3) fitted into the upper ring 4.

The camera holder 40 on which the camera module 3 has been mounted is secured with screws onto the first movable base 41. The coupling member 50 is interposed between the first movable base 41 and the second movable base 42.

The printed circuit board 90 includes a plurality of (e.g., four in this embodiment) magnetic sensors 92 for detecting rotational positions in the panning and tilting directions of the camera module 3. In this embodiment, the magnetic sensors 92 may be implemented as Hall elements, for example. On the printed circuit board 90, further assembled are a circuit for controlling the amount of a current allowed to flow through the drive coils 720, 721, 730, and 731 and other circuits.

Next, detailed configurations for the first movable base 41 and the second movable base 42 will be described.

The first movable base 41 includes a body 43, a pair of holding portions 44, a movable-end holding member 45, and a sphere 46 (see FIG. 4). The body 43 sandwiches the rigid portion 12 between itself and the camera holder 40 to fix (hold) the rigid portion 12 thereon. The respective holding portions 44 are provided for the peripheral edge of the body 43 so as to face each other (see FIG. 4). Each holding portion 44 clamps and holds an associated bundle of cables 11 between itself and a sidewall 431 of the body 43 (see FIGS. 2A and 2B). The movable-end holding member 45 has a recessed spherical surface 451 (see FIG. 1B). The movable-end holding member 45 holds the sphere 46. The radius of the recessed spherical surface 451 is larger than the radius of the sphere 46 and as large as the radius of the recessed spherical surface 503. In other words, although the recessed spherical surface 451 and the sphere 46 have different curvatures, the recessed spherical surface 451 and the recessed spherical surface 503 have the same curvature. As used herein, if the two curvatures are the same, the two curvatures may naturally be exactly the same as each other but may also be substantially the same as each other as long as their difference falls within a permissible tolerance range. When the movable-end holding member 45 holds the sphere 46 (i.e., when the sphere 46 comes into contact with the recessed spherical surface 451), a space 452 is left between them (see FIGS. 1B and 5A). The space 452 left lets the sphere 46 roll on the recessed spherical surface 451 such that the center 460 of the sphere 46 (see FIGS. 1A and 1B) shifts. In this case, the movable-end holding member 45 is formed of aluminum and the surface of the recessed spherical surface 451, in particular, is subjected to alumite (anodized aluminum) treatment.

The fixed-end holding member 502 and the movable-end holding member 45 sandwich the sphere 46 between themselves, thus allowing the fixed unit 20 to pivotally support the movable unit 10 to make the movable unit 10 rotatable.

The second movable base 42 supports the first movable base 41. The second movable base 42 includes a back yoke 610, a pair of first drive magnets 620, and a pair of second drive magnets 621 (see FIG. 4). The second movable base 42 further includes a bottom plate 640, a position detecting magnet 650, a first stopper member 651, and a second stopper member 652 (see FIG. 4).

The back yoke 610 includes a disk portion and four fixing portions (arms) extending from the outer periphery of the disk portion toward the camera module 3 (i.e., upward). Two out of the four fixing portions face each other along the X-axis, while the other two fixing portions face each other along the Y-axis. The two fixing portions facing each other along the Y-axis face the pair of first coil units 52. The two fixing portions facing each other along the X-axis face the pair of second coil units 53.

The pair of first drive magnets 620 are respectively fixed onto two fixing portions, facing each other along the Y-axis, out of the four fixing portions of the back yoke 610. The pair of second drive magnets 621 are respectively fixed onto two fixing portions, facing each other along the X-axis, out of the four fixing portions of the back yoke 610.

Electromagnetic driving by the first drive magnets 620 and the first coil units 52 and electromagnetic driving by the second drive magnets 621 and the second coil units 53 allow the movable unit 10 (camera module 3) to rotate in the panning, tilting, and rolling directions. Specifically, electromagnetic driving by the two drive coils 720 and the two first drive magnets 620 allows the movable unit 10 to rotate in the panning direction. Electromagnetic driving by the two drive coils 721 and the two second drive magnets 621 allows the movable unit 10 to rotate in the tilting direction. Meanwhile, electromagnetic driving by the two drive coils 730 and the two first drive magnets 620 and electromagnetic driving by the two drive coils 731 and the two second drive magnets 621 allow the movable unit 10 to rotate in the rolling direction.

The bottom plate 640 is a non-magnetic member and may be made of brass, for example. The bottom plate 640 is attached to the back yoke 610 to define the bottom of the movable unit 10 (i.e., the bottom of the second movable base 42). The bottom plate 640 is secured with screws onto the back yoke 610 and the first movable base 41. The bottom plate 640 serves as a counterweight. Having the bottom plate 640 serve as a counterweight allows the center of rotation to agree with the center of gravity of the movable unit 10. That is why when external force is applied to the entire movable unit 10, the moment of rotation of the movable unit 10 around the X-axis and the moment of rotation of the movable unit 10 around the Y-axis both decrease. This allows the movable unit 10 (or the camera module 3) to be held in the neutral position, or to rotate around the X- and Y-axes, with less driving force.

The back yoke 610 is fixed onto the surface, located closer to the camera module 3 (i.e., the upper surface), of the bottom plate 640.

One surface, located more distant from the camera module 3 (i.e., the lower surface), of the bottom plate 640 is a spherical surface, a central portion of which has a recess. In the recess, arranged are the position detecting magnet 650 and the first stopper member 651 (see FIG. 1A). The first stopper member 651 prevents the position detecting magnet 650, arranged in the recess of the bottom plate 640, from falling off.

The second stopper member 652 prevents the sphere 46 from falling off. A central portion of the surface, located closer to the camera module 3 (i.e., the upper surface), of the second stopper member 652 has a curved recess 653 (see FIGS. 1B and 4). A protrusion 654 protrudes from a central portion of the surface, located more distant from the camera module 3 (i.e., the lower surface), of the second stopper member 652 (see FIGS. 1B and 4).

Inserting the protrusion 654 into a through hole 611 of the back yoke 610 allows the second stopper member 652 to be fixed onto the back yoke 610.

A gap is left between the second stopper member 652 and the fixed-end holding member 502 of the coupling member 50 (see FIG. 1B). The surface, located more distant from the camera module 3, of the fixed-end holding member 502 and the bottom surface of the recess 653 are curved surfaces that face each other. This gap is wide enough to prevent the sphere 46 from falling off even if the movable unit 10 has moved upward (i.e., even if the second stopper member 652 has moved toward the fixed-end holding member 502).

The four magnetic sensors 92 provided for the printed circuit board 90 detect the relative rotation (movement) of the movable unit 10 with respect to the fixed unit 20 based on the relative position of the position detecting magnet 650 with respect to the four magnetic sensors 92. That is to say, as the movable unit 10 rotates (moves), the position detecting magnet 650 changes its position, thus causing a variation in the magnetic force applied to the four magnetic sensors 92. The four magnetic sensors 92 detect this variation in the magnetic force, and calculate two-dimensional angles of rotation with respect to the X- and Y-axes. This allows the four magnetic sensors 92 to detect the angles of rotation of the movable unit 10 in the tilting and panning directions, respectively. In addition, the camera device 1 further includes, separately from the four magnetic sensors 92, another magnetic sensor for detecting the rotation of the movable unit 10 (i.e., the rotation of the camera module 3) around the optical axis 1a, i.e., the rotation of the movable unit 10 in the rolling direction. Note that the sensor for detecting the rotation of the movable unit 10 in the rolling direction does not have to be a magnetic sensor but may also be a gyrosensor, for example.

In this case, the pair of first drive magnets 620 serves as attracting magnets, thus producing first magnetic attraction forces between the pair of first drive magnets 620 and the first magnetic yokes 710 that face the first drive magnets 620. Likewise, the pair of second drive magnets 621 also serves as attracting magnets, thus producing second magnetic attraction forces between the pair of second drive magnets 621 and the second magnetic yokes 711 that face the second drive magnets 621. The vector direction of each of the first magnetic attraction forces is parallel to a centerline that connects together the center of rotation, the center of mass of an associated one of the first magnetic yokes 710, and the center of mass of an associated one of the first drive magnets 620. The vector direction of each of the second magnetic attraction forces is parallel to a centerline that connects together the center of rotation, the center of mass of an associated one of the second magnetic yokes 711, and the center of mass of an associated one of the second drive magnets 621.

The first and second magnetic attraction forces become normal forces produced by the fixed unit 20 with respect to the sphere 46 of the fixed-end holding member 502. Also, when the movable unit 10 is in the neutral position, the magnetic attraction forces of the movable unit 10 define a synthetic vector along the Z-axis. This force balance between the first magnetic attraction forces, the second magnetic attraction forces, and the synthetic vector resembles the dynamic configuration of a balancing toy, and allows the movable unit 10 to rotate in three axis directions with good stability.

In this embodiment, the pair of first coil units 52, the pair of second coil units 53, the pair of first drive magnets 620, and the pair of second drive magnets 621 together form the driving unit 30.

The camera device 1 of this embodiment allows the movable unit 10 to rotate two-dimensionally (i.e., pan and tilt) by supplying electricity to the pair of drive coils 720 and the pair of drive coils 721 simultaneously. In addition, the camera device 1 also allows the movable unit 10 to rotate (i.e., to roll) around the optical axis 1a by supplying electricity to the pair of drive coils 730 and the pair of drive coils 731 simultaneously.

Next, a supporting structure for supporting the movable unit 10 with respect to the fixed unit 20 will be described. The supporting structure includes the sphere 46 and a pair of holding members (namely, the fixed-end holding member 502 and the movable-end holding member 45) that clamp the sphere 46 between themselves. In this embodiment, there is a space 504 that lets the sphere 46 roll so that the center 460 (i.e., the center of mass) of the sphere 46 shifts with respect to the fixed-end holding member 502. In addition, there is another space 452 that lets the sphere 46 roll so that the center 460 (i.e., the center of mass) of the sphere 46 shifts with respect to the movable-end holding member 45.

In this supporting structure, when the movable unit 10 is going to rotate in the panning direction from the neutral position (see FIG. 5A), the sphere 46 rolls through the spaces 452 and 504 first. As a result, the movable unit 10 rotates in the panning direction (see FIG. 5B). Supply of electricity to the pair of drive coils 720 causes the movable unit 10 to further rotate in the panning direction (see FIG. 5C). Note that in FIGS. 5A-5C, the shapes of the spherical surfaces 451 and 503 are not actual ones but exaggerated to make this description more easily understandable.

Likewise, when the movable unit 10 is going to rotate in the tilting direction from the neutral position, the sphere 46 also rolls through the spaces 452 and 504 to cause the movable unit 10 to rotate in the tilting direction. Thereafter, supply of electricity to the pair of drive coils 721 causes the movable unit 10 to further rotate in the tilting direction.

In the following description, the operation of causing the movable unit 10 to rotate in either the panning direction or the tilting direction by letting the sphere 46 roll through the spaces 452 and 504 will be hereinafter referred to as a “first mode,” and the operation of causing the movable unit 10 to further rotate in the same direction by supplying electricity to the pair of drive coils after having rotated in either the panning direction or the tilting direction in the first mode will be hereinafter referred to as a “second mode.” In the first mode, the position of the sphere 46 relative to the fixed-end holding member 502 changes (i.e., the position where the sphere 46 makes contact with the fixed-end holding member 502 changes) but the position where the sphere 46 makes contact with the movable-end holding member 45 does not change. In the second mode, on the other hand, the position of the sphere 46 does not change but the position of the movable-end holding member 45 changes relatively (i.e., the position where the sphere 46 makes contact with the movable-end holding member 45 changes). In other words, it can be said that in the second mode, considering from the standpoint of the movable-end holding member 45 (i.e., considering with the movable-end holding member 45 fixed), the position of the sphere 46 changes relative to the movable-end holding member 45.

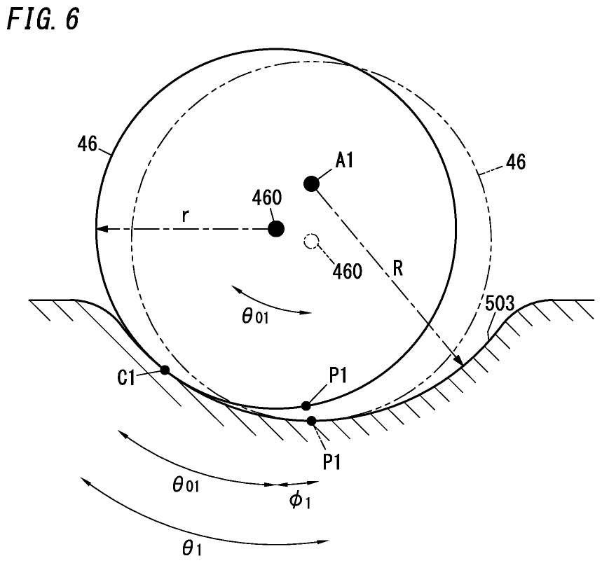

Next, the relation in magnitude between the respective radii R of the spherical surface 503 of the fixed-end holding member 502 and the spherical surface 451 of the movable-end holding member 45 and the radius r of the sphere will be described with reference to FIGS. 6-13. Note that in FIGS. 6-8 and 11, the shapes of the spherical surfaces 451 and 503 are not actual ones but exaggerated to make this description more easily understandable. In this embodiment, the center of the spherical surface 503 of the fixed-end holding member 502 is designated by A1 and the center of the spherical surface 451 of the movable-end holding member 45 is designated by A2. The respective centers A1 and A2 of the spherical surfaces 503 and 451 may be either the same position or two different positions.

In a situation where the sphere 46 has rolled in the first mode on the spherical surface 503 of the fixed-end holding member 502, the angle of movement of the sphere 46 with respect to a vertical line drawn to the center A1 of the spherical surface 503 is supposed to be θ₀₁ and the tilt angle defined by the sphere 46 with respect to the vertical line is supposed to be φ₁ (see FIG. 6). In this case, in FIG. 6, the sphere 46 before rotating in the first mode is indicated by the two-dot chain circle and the sphere 46 that has rotated (i.e., after the first mode is over) is indicated by the solid circle. The tilt angle φ₁ is an angle defined, with respect to the vertical line, by a line segment connecting a point P1 where the sphere 46 contacted with the spherical surface 503 before the first mode (i.e., before the rotation) (i.e., the point P1 of the sphere 46 indicated by the two-dot chain circle), or a point P1 after the rotation (i.e., the point P1 of the sphere 46 indicated by the solid circle), to the center 460 of the sphere 46 that has rotated. Furthermore, the angle of rotation of the sphere 46 is supposed to be θ₁ (see FIG. 6). In that case, the following Equations (1) and (2) are satisfied, and Equation (3) is derived from Equations (1) and (2). In these Equations (1), (2), and (3), the angle of rotation θ₁ is the angle formed between the line segment connecting the point of contact C1 of the sphere 46 that has rotated with the spherical surface 503 to the center 460 of the sphere 46 that has rotated and the line segment connecting the point P1 of the sphere 46 that has rotated to the center 460 of the sphere 46 that has rotated.

rθ₁=Rθ₀₁ [Equation 1]

ϕ₁=θ₁−θ₀₁ [Equation 2]

ϕ₁=θ₁×(R−r)/R [Equation 3]

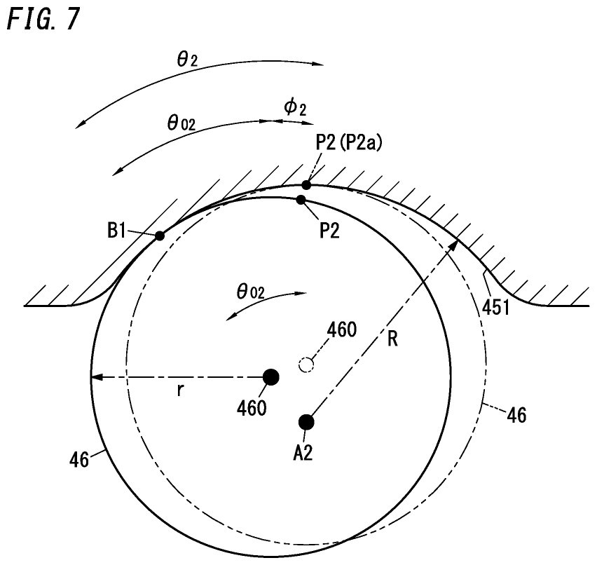

Next, a situation where the movable-end holding member 45 has rolled on the sphere 46 in the second mode (i.e., a situation where the sphere 46 has rolled on the spherical surface 451 of the movable-end holding member 45) will be described. In this case, it can be said that in the second mode, considering from the standpoint of the movable-end holding member 45 (i.e., considering with the movable-end holding member 45 fixed), the position of the sphere 46 changes relatively to the movable-end holding member 45, as described above. Thus, in FIG. 7, the sphere 46 before rotating in the second mode is indicated by the two-dot chain circle and the sphere 46 that has rotated (i.e., after the second mode is over) and has moved relatively to the movable-end holding member 45 is indicated by the solid circle. In the sphere 46 at the beginning of the second mode, the point P2 where the sphere 46 contacted with the movable-end holding member 45 (i.e., the point P2 of the sphere 46 indicated by the two-dot chain circle) shifts to a region where the sphere 46 does not contact with the movable-end holding member 45 (see the point P2 of the sphere 46 indicated by the solid circle) as a result of the relative movement of the sphere 46 with respect to the movable-end holding member 45. In the following description, the point P2 of the sphere 46 at the beginning of the second mode will be hereinafter referred to as “point P2a.” Also, the respective angles shown in FIG. 7 and to be described later are the angles defined with respect to the movable-end holding member 45 on the supposition that the sphere 46 has moved relatively to the movable-end holding member 45.

In the following description, the angle of movement formed by the sphere 46 with respect to the line segment that connects the center A2 of the spherical surface 503 to the point P2a is designated by θ₀₂, and the tilt angle of the sphere 46 is designated by φ₂ (see FIG. 7). The tilt angle φ₂ is an angle defined, with respect to the vertical line, by a line segment connecting a point P2 where the sphere 46 contacted with the spherical surface 451 right after the first mode was over (i.e., the point P2 of the sphere 46 indicated by the two-dot chain circle), or a point P2 after the rotation (i.e., the point P2 of the sphere 46 indicated by the solid circle), to the center 460 of the sphere 46 that has rotated. Furthermore, the angle of rotation of the sphere 46 is supposed to be θ₂ (see FIG. 7). In that case, the following Equations (4) and (5) are satisfied, and Equation (6) is derived from Equations (4) and (5). Since the tilt angle of the barrel of the camera module 3 is φ₁+φ₂, Equation (7) is derived from Equations (3) and (6). In these Equations (4), (5), (6), and (7), the angle of rotation θ₂ is the angle formed between the line segment connecting the point of contact B1 of the sphere 46 that has rotated with the spherical surface 451 to the center 460 of the sphere 46 that has rotated and the line segment connecting the point P2 of the sphere 46 that has rotated to the center 460 of the sphere 46 that has rotated.

rθ₂=Rθ₀₂ [Equation 4]

ϕ₂=θ₂−θ₀₂ [Equation 5]

ϕ₂=θ₂×(R−r)/R [Equation 6]

ϕ₁+ϕ₂(θ₁+θ₂)×(R−r)/R [Equation 7]

Also, although it depends on the angle of view of a given optical lens, the smallest angle that causes a sensible camera shake at the telephoto end (i.e., at the largest zoom power) is about 0.5 degrees. Therefore, control needs to be performed so as to converge the residual toward this angle or less. In this case, in a range of very small angles from −0.5 degrees to 0.5 degrees, the self-excited vibration caused by the stick slip due to a variation in friction causes a decline in the positioning performance of rotational control. Thus, a rolling friction is applied to the range of very small angles. In that case, the following Inequality (8) is satisfied. The inequality “(θ₁+θ₂)×(R−r)/R≥0.5” is obtained based on Equation (7) and Inequality (8) and may be modified into the following Inequality (9):

ϕ₁+ϕ₂≥0.5 [Inequality 8]

θ₁+θ₂≥0.5×R/(R−r) [Inequality 9]

A condition for preventing the sphere 46 from sliding at any of two points of contact B1 and C1 in a situation where a vertical load N has been produced in the camera module 3 may be represented by the following Inequalities (10) and (11), where μ is the coefficient of static friction. Inequality (10) may be modified into the following Inequality (12). Furthermore, the following Inequality (13) is obtained by substituting Equation (2) for Inequality (12). Furthermore, Inequality (11) may be modified into the following Inequality (14). The following Inequality (15) is derived from Inequalities (13) and (14).

N sin(θ₂+ϕ₁)≤μN cos(θ₂+ϕ₁) [Inequality 10]

N sin θ₀₁≤μN cos θ₀₁ [Inequality 11]

θ₂+ϕ₁≤tan⁻¹μ [Inequality 12]

θ₂+θ₁−θ₀₁≤tan⁻¹μ [Inequality 13]

θ₀₁≤tan⁻¹μ [Inequality 14]

θ₁+θ₂≤2 tan⁻¹μ [Inequality 15]

Inequality (9) needs to be satisfied due to a constraint on the tilt angle of the camera module 3. Inequality (15) needs to be satisfied to prevent the sphere 46 from sliding at any of the two points of contact B1 and C1.

If “2 tan⁻¹μ<0.5×R/(R−r)” is satisfied, then there is no optimum condition for θ₁+θ₂. Therefore, the relation between the radius R, the radius r of the sphere, and the coefficient of static friction μ is represented by “2 tan⁻¹μ≥0.5×R/(R−r).” This inequality may be modified into the following Inequality (16) as a relational expression representing the relation between the radius R, the radius r of the sphere, and the coefficient of static friction μ.

R≥r×4 tan^{-l}ρ/(4 tan⁻¹μ−1) [Inequality 16]

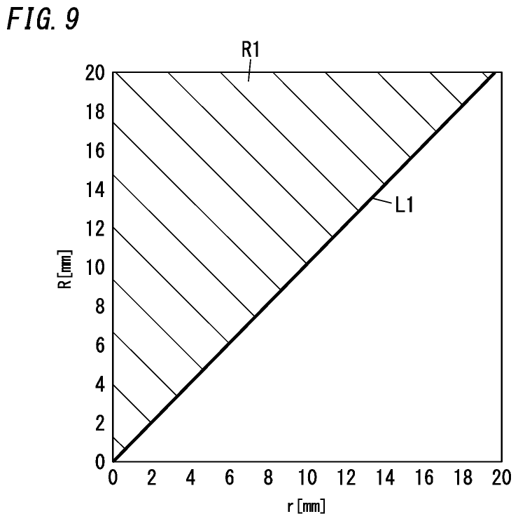

As can be seen from the foregoing description, when the rolling friction is taken into account, the relation between the respective radii R of the spherical surfaces 503 and 451, the radius r of the sphere, and the coefficient of static friction μ needs to satisfy Inequality (16). For example, supposing the coefficient of static friction μ is 0.1, the line L1 shown in FIG. 9 is obtained from Inequality (16). In that case, the range of values that the radius R may assume according to the radius r should fall within the range R1 indicated by the oblique lines in FIG. 9.

Also, the sphere 46 is molded out of resin, and the movable-end holding member 45 and the fixed-end holding member 502 are formed out of aluminum. Therefore, the sphere 46 has different hardness from (i.e., lower hardness than) the movable-end holding member 45 and the fixed-end holding member 502. In addition, the vertical load N has been produced in the sphere 46. Thus, the sphere 46 is compressed by the vertical load N, and therefore, may be deformed. That is why to reduce the deformation of the sphere 46, the relation between the respective radii R of the spherical surfaces 503 and 451 and the radius r of the sphere needs to be taken into account.

According to the Hertz contact theory, the maximum contact pressure in the case of point contact is given by the following Equation (17), where E₁ is the Young's modulus of the sphere 46, E₂ is the Young's modulus of the fixed-end holding member 502 (in particular, at the spherical surface 503), u₁ is the Poisson ratio of the sphere 46, and u₂ is the Poisson ratio of the fixed-end holding member 502 (in particular, at the spherical surface 503).

$${P}_{max} = \frac{3 N}{2 π {\{ \sqrt[3]{\frac{3}{2} N \frac{- rR}{r - R} \frac{{E}_{2} ( 1 - {v}_{1}^{2} ) + {E}_{1} ( 1 - {{v}_{2}}^{2} )}{2 {E}_{1} {E}_{2}}} \}}^{2}} \qquad [ Equation 17 ]$$

To prevent the sphere 46 from being deformed, Pₘₐₓ needs to be less than the compressive strength P_{c}. That is to say, the inequality “Pₘₐₓ<P_{c}” needs to be satisfied. In this case, supposing N=3 [N], P_{c}=100 [MPa], E₁=3000 [MPa], E₂=68.3 [GPa], u₁=0.38, and u₂=0.34, the following Equation (18) is obtained based on Equation (17) and the inequality “Pₘₐₓ<P_{c}.”

2.56r>(2.56−r)R [Inequality 18]

If the radius r of the sphere 46 is greater than 2.56 [mm], then Inequality (18) may be modified into the following Inequality (19) (hereinafter referred to as “Case 1”). If the radius r of the sphere 46 is less than 2.56, then Inequality (18) may be modified into the following Inequality (20) (hereinafter referred to as “Case 2”). If the radius r of the sphere 46 is equal to 2.56, then Inequality (18) is always satisfied, no matter what value the radius R assumes (hereinafter referred to as “Case 3”).

R>2.56r/(2.56−r) [Inequality 19]

R<2.56r/(2.56−r) [Inequality 20]

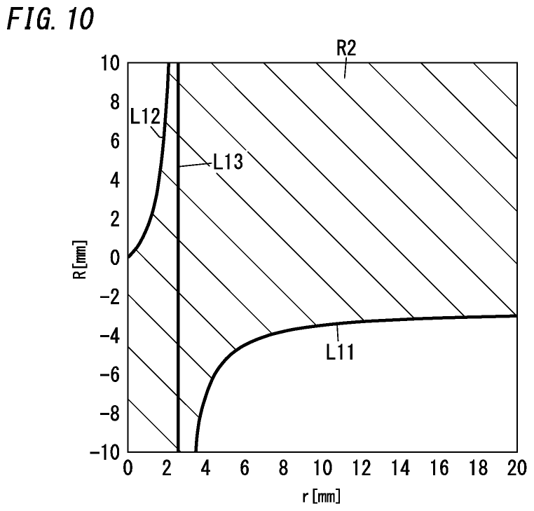

The relations between the respective radii R of the spherical surfaces 503 and 451 and the radius r of the sphere, which are obtained based on these Inequalities (18) to (20), are shown in FIG. 10. The curve L11 is obtained from the right side of Inequality (19). The curve L12 is obtained from the right side of Inequality (20). The line L13 represents Case 3. According to Inequalities (18) to (20) and these curves L11 and L12 and the line L13, the range of the values that the radii R may assume according to the radius r becomes the range R2 indicated by the oblique lines in FIG. 10.

Furthermore, when the relation between the respective radii R of the spherical surfaces 503 and 451 and the radius r of the sphere is taken into account, the magnitude of movement of the sphere 46 needs to be taken into account. This is because if the magnitude of movement of the sphere 46 is significant, then the sphere 46 rotates by just rolling in the first mode, and therefore, is no longer controllable by electromagnetic driving or supportable with good stability.

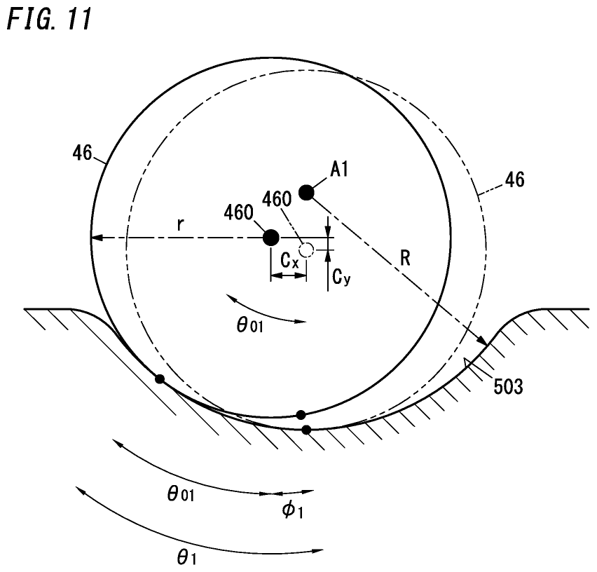

Thus, in a situation where the sphere 46 has rolled on the spherical surface 503 of the fixed-end holding member 502 in the first mode as described above, the angle of movement of the sphere 46 with respect to a vertical line drawn to the center of the spherical surface 503 is supposed to be θ₀₁, the tilt angle of the sphere 46 is supposed to be φ₁, and the angle of rotation of the sphere 46 is supposed to be θ₁ (see FIG. 11). In FIG. 11, the sphere 46 before rotating in the first mode is indicated by the two-dot chain circle and the sphere 46 that has rotated (i.e., after the first mode is over) is indicated by the solid circle.

The magnitude of movement of the sphere 46 that has moved from the center 460 before the first mode began (i.e., before the rotation) (i.e., the center 460 of the two-dot chain circle) to the center 460 after the rotation (i.e., the center of the solid circle) is supposed to be “cₓ” with respect to the horizontal direction and “c_{y}” with respect to the vertical direction (see FIG. 11). In that case, the magnitude of movement cₓ of the center 460 of the sphere 46 with respect to the horizontal direction is given by the following Equation (21) and the magnitude of movement c_{y} of the center 460 of the sphere 46 with respect to the vertical direction is given by the following Equation (22):

cₓ=(R−r)×sin θ₀₁ [Inequality 21]

c_{y}=(R−r)×(1−cos θ₀₁) [Inequality 22]

In this case, if the value of the coefficient of static friction μ is 0.1, then the value of θ₀₁ is calculated 5.71 [deg] by Inequality (14). Also, if the tolerance of the magnitude of movement of the center 460 of the sphere 46 is 0.15 [mm], then the inequalities cₓ<0.15 and c_{y}<0.15 are satisfied. The following Inequality (23) is obtained by substituting a value of 5.71 for Ow in Equation (21), and the following Inequality (24) is obtained by substituting a value of 5.71 for θ₀₁ in Equation (22).

R≤1.51+r [Inequality 23]

R≤30.2+r [Inequality 24]

The relation between the respective radii R of the spherical surfaces 503 and 451 and the radius r of the sphere 46 needs to satisfy both of Inequalities (23) and (24). In that case, when Inequality (23) is satisfied, then Inequality (24) is also satisfied.

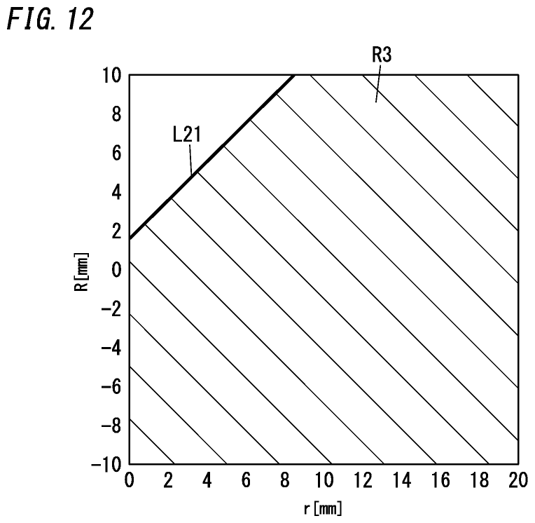

The relation between the respective radii R of the spherical surfaces 503 and 451 and the radius r of the sphere 46, which is based on Inequality (23), is shown in FIG. 12. The line L21 is obtained from the right side of Inequality (23). In that case, the range of the values that the radii R may assume according to the radius r should fall within the range R3 indicated by the oblique lines in FIG. 12.

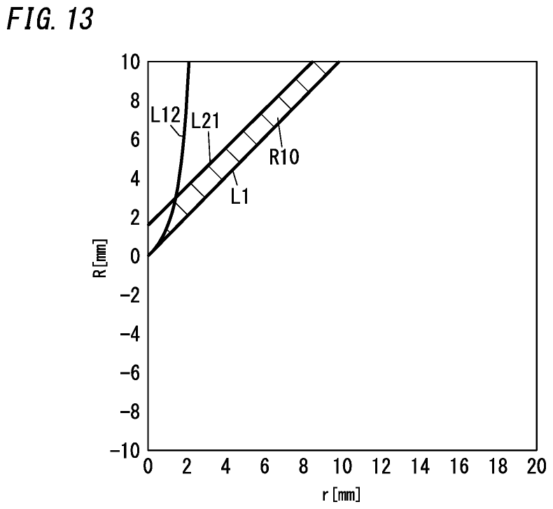

As can be seen from the foregoing description, the relation between the respective radii R of the spherical surfaces 503 and 451 and the radius r of the sphere 46 needs to be determined so as to reduce the rolling friction and the deformation of the sphere 46 and to constrain the magnitude of movement of the center 460 of the sphere 46. Taking all of these factors into consideration, the relation between the respective radii R of the spherical surfaces 503 and 451 and the radius r of the sphere 46 needs to satisfy all of Inequalities (16), (18), and (23). If a region that satisfies all of Inequalities (16), (18), and (23) is designated by R10, then the region R10 is indicated by the oblique lines in FIG. 13. The respective radii R of the spherical surfaces 503 and 451 and the radius r of the sphere 46 are suitably picked from the region R10. For example, the radius r of the sphere 46 may be 1.9 [mm] and the respective radii R of the spherical surfaces 503 and 451 may be 2.05 [mm].

Note that the relation between the respective radii R of the spherical surfaces 503 and 451 and the radius r of the sphere 46 is most suitably determined with reduction of the rolling friction and the deformation of the sphere 46 and constraint on the magnitude of movement of the center 460 of the sphere 46 both taken into account. However, the scope of the present disclosure also covers a situation where at least one of these conditions is satisfied.

As already described in the Background Art section, in the known actuator (actuator as a comparative example), the known movable unit is supported by the known fixed unit so as to be loosely fitted into the fixed unit. Thus, in a state where the known movable unit stands still with respect to the fixed unit, the known movable unit and the known fixed unit together behave as a coupled rigid body due to the static friction produced between them. When the known movable unit is going to be rotated from this state, the stick slip occurs due to a variation in friction during the transition from the resting state to the kinetic state. Then, a saw-toothed torque pulsation caused by this stick slip excites the characteristic vibration of the rigid body that is temporarily coupled together due to the static friction.

In that case, the frequency will be a relatively high frequency (of 300 Hz, for example). Once the known movable unit starts its rotary motion, the coupling between the movable unit and the fixed unit due to the static friction is canceled, and thereafter, the movable unit behaves as an object with a characteristic vibration (with a frequency of 30 Hz, for example) as a single pendulum. That is to say, in the known movable unit, if a relatively low voltage is applied during the initial stage of rotation to let the movable unit start rotating smoothly, then a characteristic vibration with a high frequency would be temporarily excited due to the stick slip phenomenon to cause instability to the rotational control system during that period, and eventually produce oscillation in a worst-case scenario. To avoid such a scenario, it has been considered an effective measure to decrease the gain of the rotational control. However, this would prevent the movable unit from start or stop moving smoothly. In short, in the actuator as a comparative example, the known movable unit causes so much frictional variation during the transition from the resting state to the kinetic state that its own peculiar, characteristic vibration would be produced only during the initial stage of rotation, thus causing a decline in stability of control and posing an obstacle to the improvement of positioning performance of the rotational control.

On the other hand, the actuator 2 according to this embodiment sets the respective radii R of the spherical surfaces 503 and 451 at a value larger than the radius r of the sphere 46 to leave spaces 452 and 504, thus allowing the sphere 46 to roll freely. Thus, the actuator 2 according to this embodiment reduces the stick slip phenomenon by letting the sphere move due to the rolling friction during the initial stage of the rotary motion of the movable unit 10, and allows only the characteristic vibration (with a frequency of 30 Hz, for example) as a pendulum to be set up without exciting the characteristic vibration with a relatively high frequency as is observed in the actuator as a comparative example. That is to say, in the actuator 2 according to this embodiment, the magnitude of the frictional variation during the transition from the resting state to the kinetic state is so much smaller than the magnitude of the frictional variation in the actuator as a comparative example as to reduce the occurrence of the special characteristic vibration only during the initial stage of the rotary motion, improve the stability of control, and eventually improve the positioning performance of the rotational control.

This embodiment compensates for a shake of the camera module 3 by controlling the rotation of the camera module 3 by electromagnetic driving. In this case, the camera device 1 according to this embodiment determines the respective radii R of the spherical surfaces 503 and 451 and the radius r of the sphere 46 such that the sphere 46 rolling defines a tilt angle of −0.5 to 0.5 degrees with respect to the Z-axis of the camera module 3. That is why when the tilt angle defined by the sphere 46 with respect to the Z-axis of the camera module 3 falls within the range from −0.5 to 0.5 degrees through the electromagnetic driving in the second mode, the camera device 1 is allowed to make a transition to the first mode as a mode for controlling the rotation of the camera module 3 (movable unit 10). Compared to the situation where control is performed only through electromagnetic driving, the camera device 1 is easily controllable at an angle which is even smaller than the smallest angle (of 0.5 degrees) at which a camera shake is sensible on the video.

(Variations)

Note that the embodiment described above is only an exemplary one of various embodiments of the present invention and should not be construed as limiting. Rather, the exemplary embodiment described above may be readily modified in various manners depending on a design choice or any other factor without departing from a true spirit and scope of the present invention.

In the embodiment described above, a grease pool may be provided by injecting grease into the space 452 left between the sphere 46 and the movable-end holding member 45 and the space 504 left between the sphere 46 and the fixed-end holding member 502 to let the sphere 46 roll smoothly. Note that the grease pool does not have to be provided in both of these spaces 452 and 504 but may be provided in only one of these spaces 452 and 504.

Also, in the embodiment described above, the sphere 46 is not fixed to the pair of holding members (namely, the fixed-end holding member 502 and the movable-end holding member 45). However, this configuration is only an example and should not be construed as limiting. Alternatively, the sphere 46 may be fixed to one of the pair of holding members.

Furthermore, in the embodiment described above, the pair of holding members (namely, the fixed-end holding member 502 and the movable-end holding member 45) is configured to have a recessed spherical surface. However, this configuration is only an example and should not be construed as limiting. Alternatively, one of the pair of holding members does not have to have such a recessed spherical surface, as long as the surface is recessed. For example, the recessed surfaces may be curved surfaces with two different radii of curvature or tapered surfaces (in the shape of a mortar, for example). In that case, the sphere 46 may be fixed onto the holding member that has the recessed non-spherical surface.

Furthermore, in the embodiment described above, the coupling member 50 and the movable-end holding member 45 are formed out of aluminum. In particular, both of the spherical surfaces 503 and 451 with the recessed shape are subjected to alumite treatment, while the sphere 46 is molded out of resin. However, this configuration is only an example and should not be construed as limiting. Alternatively, the sphere 46 may be formed out of aluminum, of which the surface has been subjected to alumite treatment, and the coupling member 50 and the movable-end holding member 45 may be molded out of resin. In that case, a vertical load N will be produced between the sphere 46 and the pair of holding members (namely, the movable-end holding member 45 and the fixed-end holding member 502), and the pair of holding members will be compressed under the vertical load N, thus possibly deforming the pair of holding members. Thus, to reduce the deformation of the pair of holding members, the relation between the respective radii R of the spherical surfaces 503 and 451 and the radius r of the sphere 46 needs to be considered. In that case, the relation between the radii R and the radius r of the sphere 46 is the same as expressed by Inequality (18). Note that not both of the pair of holding members (namely, the movable-end holding member 45 and the fixed-end holding member 502) have to be molded out of resin, but at least one of the pair of holding members may be molded out of resin.

Furthermore, the actuator 2 according to the embodiment described above is applied to the camera device 1. However, this configuration is only an example and should not be construed as limiting. Alternatively, the actuator 2 is also applicable for use in a laser pointer, a haptic device, or any other appropriate device. For example, when the actuator 2 is applied to a laser pointer, a module for emitting a laser beam is provided for the movable unit 10. When the actuator 2 is provided for a haptic device, a lever is provided for the movable unit 10.

(Resume)

As can be seen from the foregoing description, an actuator (2) according to a first aspect includes: a movable unit (10) configured to hold an object to be driven; a fixed unit (20) configured to support the movable unit (10) thereon to make the movable unit (10) rotatable; and a structure for supporting the movable unit (10) with respect to the fixed unit (20). The structure includes: a sphere (46); and a pair of holding members (namely, a fixed-end holding member 502 and a movable-end holding member 45) configured to clamp the sphere (46) between themselves. A space is left to let the sphere (46) roll while shifting a center position thereof with respect to at least one of the pair of holding members.

This configuration leaves a space that lets the sphere (46) roll with respect to at least one of the pair of holding members, thus allowing the sphere (46) to move freely. This allows the movable unit (10) to be supported like a balancing toy. Therefore, this actuator (2) reduces a variation in the friction when the movable unit (10) starts moving, thus reducing the stick slip and the self-excited vibration caused by the stick slip and stabilizing the rotational control. Consequently, this allows the movable unit (10) to start and stop moving smoothly.

In an actuator (2) according to a second aspect, which may be implemented in conjunction with the first aspect, the sphere (46) is not fixed to any of the pair of holding members.

This configuration reduces the difference between the static frictional force and kinetic frictional force in the movable unit (10). This allows the movable unit (10) to start rotating smoothly during the initial stage of its rotary motion.

In an actuator (2) according to a third aspect, which may be implemented in conjunction with the first or second aspect, at least one of two contact surfaces between the pair of holding members and the sphere (46) is a recessed spherical surface (the spherical surface 503 or the spherical surface 451).

According to this configuration, making at least one of the two contact surfaces between the pair of holding members and the sphere (46) a recessed spherical surface allows the movable unit (10) to rotate smoothly.

In an actuator (2) according to a fourth aspect, which may be implemented in conjunction with the first or second aspect, both of two contact surfaces between the pair of holding members and the sphere (46) are recessed spherical surfaces.

According to this configuration, making both of the two contact surfaces between the pair of holding members and the sphere (46) recessed spherical surfaces allows the movable unit (10) to rotate even more smoothly.

In an actuator (2) according to a fifth aspect, which may be implemented in conjunction with the third or fourth aspect, the contact surface between at least one of the pair of holding members and the sphere (46) is the recessed spherical surface having a radius (R) larger than the radius (r) of the sphere (46).

This configuration allows a space that lets the sphere (46) roll while shifting its center position to be left with reliability when the pair of holding members holds the sphere (46).

In an actuator (2) according to a sixth aspect, which may be implemented in conjunction with the fifth aspect, the radius (R) of the recessed spherical surface of the holding member is larger than the product of the radius (r) of the sphere (46) and (4×tan⁻¹ (coefficient of static friction of the spherical surface)/(4× tan⁻¹ (coefficient of static friction of the spherical surface)−1).

This configuration allows the radius (R) of the recessed spherical surface of the holding member and the radius of the sphere (46) to be determined with the rolling friction taken into consideration.

In an actuator (2) according to a seventh aspect, which may be implemented in conjunction with the sixth aspect, the movable unit (10) is configured to rotate by electromagnetic driving. The radius (R) of the recessed spherical surface of the holding member is defined so as to prevent pushing force applied to the sphere (46) by magnetic force for use to control rotation of the movable unit by electromagnetic driving from deforming the sphere (46) or at least one of the pair of holding members.

This configuration allows the radius of the recessed spherical surface of the holding member and the radius of the sphere (46) to be defined so as to reduce the deformation of the sphere (46) or at least one of the pair of holding members.

In an actuator (2) according to an eighth aspect, which may be implemented in conjunction with the seventh aspect, the radius (R) of the recessed spherical surface of the holding member is defined such that magnitude of movement of a center of the sphere (46) is equal to or less than a prescribed value.

This configuration allows the radius of the recessed spherical surface of the holding member and the radius of the sphere (46) to be defined with the magnitude of movement of the sphere (46) taken into account.

In an actuator (2) according to a ninth aspect, which may be implemented in conjunction with any one of the first to eighth aspects, a grease pool is provided for the space.

This configuration allows the sphere (46) to roll even more smoothly.

A camera device according to a tenth aspect includes: the actuator (2) according to any one of the first to ninth aspects; and a camera module (3) serving as the object to be driven.

This configuration allows the camera device (1) to reduce a variation in the friction when the movable unit (10) starts moving, thus reducing the self-excited vibration caused by the stick slip and stabilizing the rotational control. Consequently, this allows the movable unit (10) to start and stop moving smoothly.

### REFERENCE SIGNS LIST

1 Camera Device
2 Actuator
3 Camera Module
10 Movable Unit
20 Fixed Unit
45 Movable-End Holding Member
46 Sphere
451, 503 Spherical Surface
452, 504 Space
502 Fixed-End Holding Member

1. An actuator comprising:
a movable unit configured to hold an object to be driven;
a fixed unit configured to support the movable unit thereon to make the movable unit rotatable; and
a structure for supporting the movable unit with respect to the fixed unit, the structure including:
a sphere; and
a pair of holding members configured to clamp the sphere between themselves,
a space being left to let the sphere roll while shifting a center position thereof with respect to at least one of the pair of holding members.

2. The actuator of claim 1, wherein
the sphere is not fixed to any of the pair of holding members.

3. The actuator of claim 1, wherein
at least one of two contact surfaces between the pair of holding members and the sphere is a recessed spherical surface.

4. The actuator of claim 1, wherein
both of two contact surfaces between the pair of holding members and the sphere are recessed spherical surfaces.

5. The actuator of claim 3, wherein
the contact surface between at least one of the pair of holding members and the sphere is the recessed spherical surface having a larger radius than the sphere.

6. The actuator of claim 5, wherein
the radius of the recessed spherical surface of the holding member is larger than a product of the radius of the sphere and (4×tan⁻¹ (coefficient of static friction of the spherical surface)/(4×tan⁻¹ (coefficient of static friction of the spherical surface)−1).

7. The actuator of claim 6, wherein
the movable unit is configured to rotate by electromagnetic driving, and
the radius of the recessed spherical surface of the holding member is defined so as to prevent pushing force applied to the sphere by magnetic force for use to control rotation of the movable unit by electromagnetic driving from deforming the sphere or at least one of the pair of holding members.

8. The actuator of claim 7, wherein
the radius of the recessed spherical surface of the holding member is defined such that magnitude of movement of a center of the sphere is equal to or less than a prescribed value.

9. The actuator of claim 1, wherein
a grease pool is provided for the space.

10. A camera device comprising:
the actuator of claim 1; and
a camera module serving as the object to be driven.
